(19) United States
(12) Patent Application Publication
(10) Pub. No.: US 2006/0065409 A1
(43) Pub. Date: Mar. 30, 2006

(54) Shoe nail set

(76) Inventor: Ching-Huang Wu, Gueishan Township (TW)

Correspondence Address: TROXELL LAW OFFICE PLLC, ONE SKYLINE PLACE, SUITE 1404, 5205 LEESBURG PIKE, FALLS CHURCH, VA, 22041, US

(21) Appl. No.: 11/130,098

(22) Filed: May 17, 2005

(30) Foreign Application Priority Data
Sep. 24, 2004 (TW) 093215263

(51) Int. Cl. A01L 7/10

(52) U.S. Cl. 168/23

(57) ABSTRACT

A shoe nail set includes a connecting part and a nail part. The connecting part has a connecting post extending outward from the center thereof and a plurality of screw threads at the periphery thereof with equal angular distant spacing apart each other and a plurality of wedges and arc blocks being disposed alternately surrounding the post. The nail part provides an annular edge surrounding the wedges and the arc blocks and a plurality of nail legs extends downward and outward. The connecting part engages with a nail base disposed at a shoe sole.

### FIELD OF THE INVENTION

The present invention relates to a shoe nail set, and, particularly to a shoe nail set suitable of golf shoe.

### BACKGROUND OF THE INVENTION

Generally, shoes are worn daily and we are wearing different shoes in different situations such as slippers being worn indoors, lather shoes or cloth shoes being worn outdoors and sports shoes during taking excises. Of course, sports shoes broadly refer to running shoes, sneakers, spikes and etc.

Sports shoes provide a function of holding ground force in addition to snugness without interfering movement. Especially, the holding ground force of the sole becomes more important that in case of steadiness of touching ground being needed. Therefore, design of shoe sole is a subject worth us to care.

Taking the golf as an example, the lawn is location of playing golf and the holding ground force being deep into the soil is required for the player standing firmly so that shoe nails of the golf shoes are cared by the suppliers and the material thereof has been changed to high molecular material instead of metallic material.

The conventional shoe nail set has a nail base fixedly attached to the shoe sole and the shoe nails are easily worn out so that they are made independently and renewable. That is, the shoe nails are provided to be corresponding to the nail base so as to make setting up and detached possible. Hence, the shoe nails fitting with the nail base and structure of the shoe nails are incapable of ignoring.

### SUMMARY OF THE INVENTION

An object of the present invention is to provide a shoe nail set, which includes a connecting part and a nail part. The connecting part has a connecting post extending outward from the center thereof and a plurality of screw threads at the periphery thereof with equal angular distant spacing apart each other and a plurality of wedges and arc blocks being disposed alternately surrounding the post. The nail part provides an annular edge surrounding the wedges and the arc blocks and a plurality of nail legs extends downward and outward. The connecting part engages with a nail base disposed at a shoe sole.

### BRIEF DESCRIPTION OF THE DRAWINGS

The present invention can be more fully understood by reference to the following description and accompanying drawings, in which:

FIG. 1 is an exploded perspective view of a shoe nail set according to the present invention;

FIG. 2 is another perspective view of the shoe nail set according the present invention projected from another direction; and

FIG. 3 is a perspective view illustrating shoe nails associated with a nail base according to the present invention.

### DETAILED DESCRIPTION OF THE INVENTION

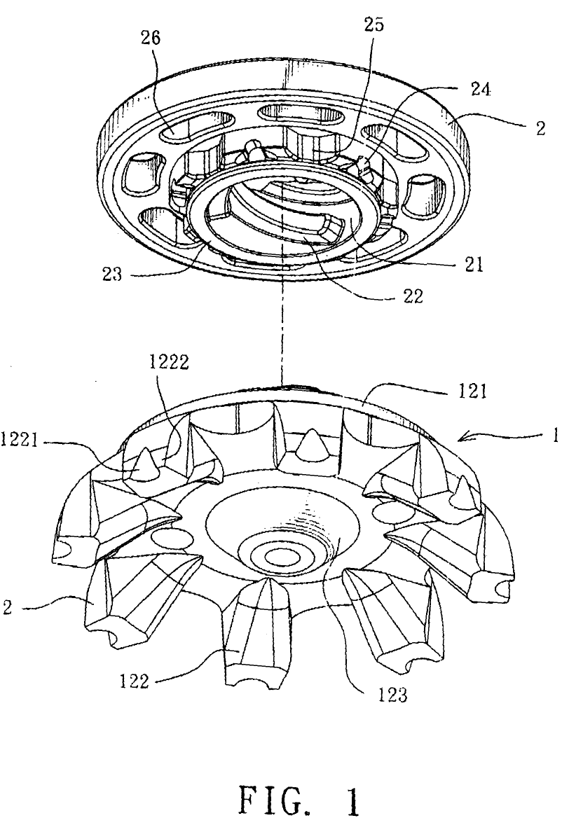

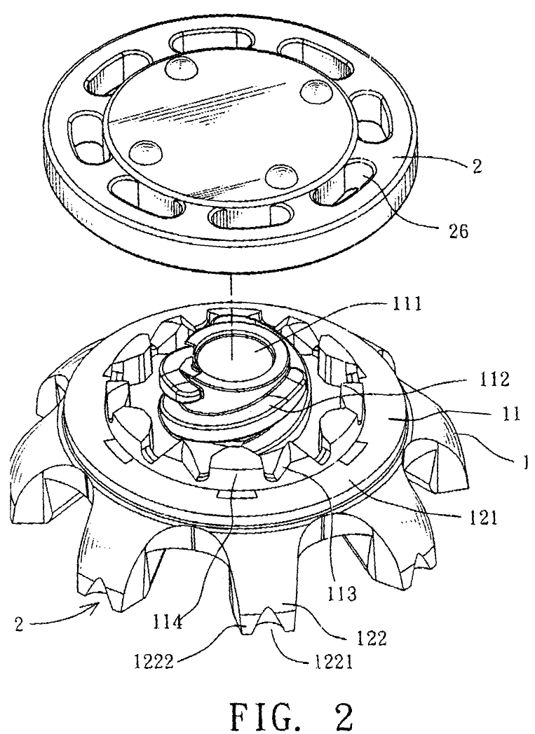

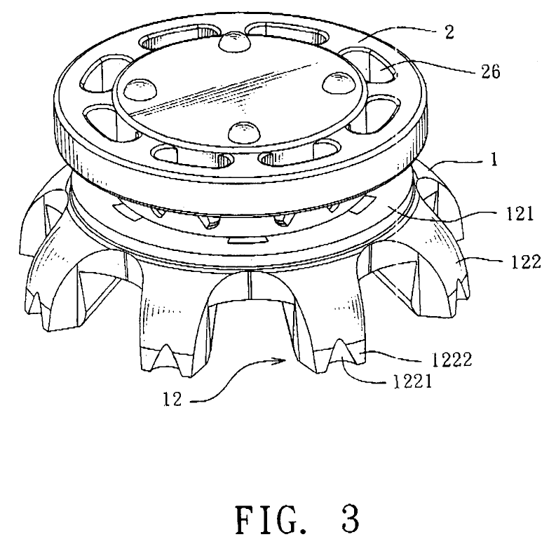

Referring to FIGS. 1 to 3, a shoe nail set according to the present invention basically has shoe nail 1 and a nail base 2.

Wherein, the shoe nail 1 is made of high molecular material and provides a connecting part 11 and a nail part 12. The connecting part 11 has a connecting post 111 extending outward from the center thereof and at least two high lead screw threads 112 at the periphery thereof with equal distant spacing from each other. It can be seen in the figures that there are three high lead screw threads 112 spacing apart 120° from each other. The connecting part 11 has an annular edge 121 with a plurality of triangular wedges 113 and arc blocks 114 being disposed alternately at the inside of the annular edge 121 surrounding the post 111.

The nail part 12 surrounds the annular edge 121 from top and a plurality of nail legs 122 are disposed under the annular edge 121 and extends outward in a way of equally spacing apart from each other. It can be seen in FIG. 1 that there are eight nail legs 122 but it is noted that this is an embodiment not a limitation of the application. The outer lower end of each nail leg 122 has a leg recess 1221 converging toward the center thereof to form two toe parts 1222. Besides, the bottom of the nail part 12 extends a nail cone with a flat head.

The nail base 2 is made of high molecular material too and provides a size corresponding to the shoe nail 1 so as to be joined to the shoe nail 1. Thus, the nail base 2 has a base bore 21 with base screw threads 22 at the inner wall thereof corresponding to the screw threads 112. In addition, a base ring 23 surrounds the base hole 21 with the outer side thereof providing wedge recesses 24 and arc recesses 25 corresponding to the wedge 113 and the arc blocks 114 respectively. Besides, the nail base 2 has a plurality of joining through holes 26 for being integrated with molten material of shoe sole.

Referring to the preceding figures again, the nail base 2 is made integrally with the shoe sole so that the joining through holes 26 are filled with the molten material of shoe sole and it results in the nail base 2 being joined to the shoe sole and the shoe nail 1 can be fastened to nail base 2 with the connecting part 11 engaging with the base hole 21.

The shoe nail 1 is easily worn out and can be loosened for renewal when necessary such that life span of the sport shoes can be extended effectively.

It is appreciated that the shoe nail set according to the present invention has the following advantages:
(1) High lead screw thread design is available for fast tightening and loosening and equal angular spacing design provides multiple tightening timings. If three screw threads are equally angular distantly apart from each other, it is capable of meeting a tightening chance once at each 120°. By the same token, four screw threads are provided and a tightening chance can be met at each 90°.
(2) The wedge and arc block being designed based on ratchet principle provide axial and radial lock actions to prevent the shoe nail from falling out due to being impacted with external force.
(3) The extension type nail legs are suspended and supported independently to comply with courts in different geologies and the nail cone is used to prevent the nail legs from rupture and break due to excessive deformation so as to extend life span of the shoe nail.
(4) The shoe nail set of the present invention is mostly made of high molecular material with climate proof, wear resistance and rust resistance.
(5) The nail legs being distributed with equal angular distance is capable of meeting the regulation of no grass being hurt in addition to providing holding ground force and comfort.

While the invention has been described with reference to the a preferred embodiment thereof, it is to be understood that modifications or variations may be easily made without departing from the spirit of this invention, which is defined by the appended claims.

What is claimed is:

1. A shoe nail set, comprising:
a connecting part, having a connecting post extending outward from the center thereof and a plurality of screw threads at the periphery thereof with equal angular distant spacing from each other and a plurality of wedges and arc blocks being disposed alternately surrounding the post; and
a nail part, providing an annular edge surrounding the wedges and the arc blocks and a plurality of nail legs extending downward and outward;
whereby, the connecting part engages with a nail base disposed at a shoe sole.

2. The shoe nail set as defined in claim 1 is made of high molecular material.

3. The shoe nail set as defined in claim 1, wherein there are three the screw threads are disposed spacing 120° apart from each other.

4. The shoe nail set as defined in claim 1, wherein each of the wedges is triangular shape with a slant surface.

5. The shoe nail set as defined in claim 1, wherein each of the nail legs has a central recess at the outer end thereof with two toe parts.

6. The shoe nail set as defined in claim 1, wherein there are eight nail legs disposed equally spaced apart from each other.

7. A nail base used in a shoe nail set, being made of high molecular material, comprising:
a central base bore, providing base threads at the inner wall thereof;
a base ring, surrounding the base bore and providing a plurality of wedge recesses and arc recesses at the outer side thereof alternately; and
a main body, providing a plurality of material holes;
whereby, the nail base is integrated with a shoe sole and engages with a shoe nail in the shoe nail set with the wedge recesses and the arc recesses meshing with a plurality of wedge and arc blocks in the shoe nail set tightly.
